(19) United States
(12) Patent Application Publication
(10) Pub. No.: US 2010/0304059 A1
(43) Pub. Date: Dec. 2, 2010

(54) MATERIAL WITH PHOTOCATALYTIC PROPERTIES

(75) Inventors: Sophie Besson, Compiegne (FR); Francois-Julien Vermersch, Paris (FR); Arnaud Huignard, Compiegne (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN GLASS FRANCE, Courbevoie (FR)

(21) Appl. No.: 12/676,619

(22) PCT Filed: Sep. 9, 2008
(86) PCT No.: PCT/FR08/51602

§ 371 Date: Mar. 5, 2010

(30) Foreign Application Priority Data
Sep. 10, 2007 (FR) 0757467

(51) Int. Cl. C03C 17/00; B32B 17/06; B32B 9/00; C03C 17/34; C03C 17/23; C04B 41/89; G02B 1/10; E06B 3/00

(52) U.S. Cl. 428/34; 428/702; 428/432; 428/446; 428/699; 428/701; 428/696; 428/700; 428/410

(57) ABSTRACT

The subject of the invention is a material comprising a substrate coated on at least one portion of at least one of its faces with a coating comprising photocatalytic titanium oxide, characterized in that said substrate and/or a coating placed between said substrate and said coating comprising photocatalytic titanium oxide comprises at least one compound capable of converting radiation having a wavelength in the visible or infrared range to radiation having a wavelength in the ultraviolet range.

The present invention relates to the field of photocatalytic materials, in particular materials having a photocatalytic activity when they are subjected to low-energy radiation.

Titanium oxide, in particular when it is crystallized in anatase form, has photocatalytic properties: excited by radiation having a wavelength that is less than or equal to 380 nm, therefore located in the ultraviolet range, it has the particularity of catalyzing radical oxidation reactions. Under the effect of the radiation, an electron-hole pair is created which helps to degrade the organic compounds possibly present on the surface of the titanium oxide. A material comprising a coating based on photocatalytic titanium oxide thus has the following particularly appreciable properties: it is self-cleaning, antibacterial, or else purifies polluted liquid or gaseous effluents. Such materials are known, for example, from Application EP-A-0 850 204.

One drawback of titanium oxide is that its photocatalytic activity is mainly initiated by high-energy radiation, in this case ultraviolet radiation. This drawback is not prejudicial when the material is exposed to solar radiation, as the latter comprises components in the ultraviolet, but it becomes so when the material is located in a place that is not subjected to very much ultraviolet radiation (room of a dwelling, passenger compartment of a vehicle, tunnel, etc.). The major part of solar ultraviolet radiation is in fact absorbed by the glazing units, whereas the artificial light sources only emit weakly in the ultraviolet. It is therefore desirable to develop photocatalytic layers for which the activity may be increased for wavelengths located in the visible or even infrared range.

Solutions to this problem have been proposed, which consist, in particular, in doping the crystal lattice of the titanium oxide with various atoms (for example, nitrogen) for the purpose of modifying the gap between the valence and conduction bands of titanium oxide. Such solutions are, for example, described in Application WO 2005/102953.

These solutions are not however free of drawbacks, since the material thus doped has an absorption in the visible range, therefore a certain coloration. The doping creates, in addition, defects in the structure of the titanium oxide which lead to a reduction in the quantum efficiency.

The objective of the invention is to provide a photocatalytic material based on titanium oxide, the photocatalytic activity of which may be raised even in the absence of ultraviolet radiation while being free of the aforementioned drawbacks.

For this purpose, one subject of the invention is a material comprising a substrate coated on at least one portion of at least one of its faces with a coating comprising photocatalytic titanium oxide. The material is characterized in that said substrate and/or a coating placed between said substrate and said coating comprising photocatalytic titanium oxide comprises at least one compound capable of converting radiation having a wavelength in the visible or infrared range to radiation having a wavelength in the ultraviolet range.

The compound capable of converting radiation having a wavelength in the visible or infrared range to radiation having a wavelength in the ultraviolet range will be referred to as a “wavelength-converting compound” throughout the remainder of the text and also in the claims. It is understood that this term cannot be interpreted differently. It cannot, in particular, be interpreted as covering compounds that are not capable of emitting ultraviolet radiation, or as covering compounds that are capable of converting radiation in the ultraviolet range to radiation in the visible or infrared range.

Within the meaning of the present invention, the ultraviolet range comprises the wavelengths between 100 and 400 nm. The visible range comprises the wavelengths between 400 and 800 nm. The infrared range comprises the wavelengths between 800 nm and 12 microns.

Fluorescent compounds have the particularity, when they are subjected to radiation of a given wavelength, of re-emitting a second radiation of higher wavelength, and therefore of lower energy than that of the incident radiation.

Compounds capable of emitting radiation of higher energy than the incident radiation have, however, been recently discovered. This phenomenon, which is explained by successive absorptions of several photons by one and the same ion or by absorptions by different ions followed by transfers of energy between said ions, is extremely rare. Indeed, it only occurs for a few ions, in particular ions of rare earths or of transition metals. Moreover, the associated luminescence efficiency is generally very low since the probability of the phenomenon occurring is itself very low. Among these compounds, some convert infrared radiation to visible radiation, and find applications in the field of imaging, photovoltaism, etc. Other rarer compounds which are referred to as “wavelength-converting compounds” in the context of the invention are capable of converting visible or infrared radiation to ultraviolet radiation.

In the material according to the invention, such a compound is present under the photocatalytic coating based on titanium oxide, either within a sublayer, or within the substrate itself. The operating principle of the invention may be schematically presented in the following manner: since titanium oxide is transparent to the major part of the visible or infrared radiation, this radiation passes through the photocatalytic coating, then is partly absorbed by the wavelength-converting compound. This compound then isotropically re-emits ultraviolet radiation, one portion of which is absorbed by the titanium oxide. The titanium oxide, excited by this ultraviolet radiation, then plays its role as photocatalyst to the full. It is important that the wavelength-converting compound is placed under the photocatalytic coating and not on top of it since the organic soiling must be in contact with the titanium oxide.

The substrate is preferably made of glass (especially made of soda-lime-silica or borosilicate glass), made of ceramic, made of glass-ceramic or made of a polymer material. It is advantageously flat or curved. The substrate is preferably at least partially transparent. The substrate may also be fibrous, for example a blanket of mineral wool (glass wool or rock wool), a felt or fabric of glass or silica fibers. When the substrate is made of a polymer material, it is preferably made of polycarbonate, polymethyl methacrylate (PMMA), polyvinyl chloride (PVC), polyethylene or polypropylene.

The titanium oxide is preferably at least partially crystallized in anatase form, as this is the most active crystalline form. The rutile form, alone or as a mixture with the anatase form, is also advantageous.

The coating comprising the titanium oxide may be composed of titanium oxide: it may be, for example, a coating obtained by processes that use organometallic precursors of titanium oxide in liquid, solid or gaseous form, such as the processes of the sol-gel type or CVD (chemical vapor deposition, optionally plasma-enhanced, preferably under atmospheric pressure) type. It may also be coatings obtained by physical vapor deposition (PVD) techniques such as sputtering, especially enhanced by a magnetic field (magnetron sputtering process), or evaporation. Techniques for depositing titanium oxide via a magnetron sputtering process are, for example, described in Application WO 02/24971. In the case of a deposition via a magnetron sputtering process, sublayers that promote the epitaxial growth of anatase TiO₂, in particular BaTiO₃ or SrTiO₃, may be deposited first, as described in Application WO 2005/040058.

The coating comprising titanium oxide may also comprise particles of titanium oxide dispersed in an organic and/or mineral binder, especially a mineral binder obtained via a sol-gel process. The particles preferably are of nanoscale size (nanoparticles), especially having an average diameter between 0.5 and 100 nm, in particular between 1 and 80 nm. They are generally composed of clusters of individual crystallites or grains having a diameter between 0.5 and 10 nm. The particles are preferably at least partly crystallized in anatase form. The binder is preferably a mineral binder so that it is not degraded by the photocatalytic activity of the titanium oxide. It is preferably based on silica (SiO₂), alumina (Al₂O₃), zirconia (ZrO₂), or on any mixture thereof. The coating comprising titanium oxide is advantageously obtained by a sol-gel process, for example by laminar flow-coating, spin-coating, or else cell-coating of solutions comprising a precursor of the binder (generally an organometallic compound) and titanium oxide particles. The binder is preferably a silica (SiO₂) binder, which may be easily obtained by a sol-gel process from silicon alcoholates (for example, TEOS, tetraethoxy-silane). This binder, in particular the silica binder, may advantageously be mesoporous, in the sense that it contains generally ordered pores having a size between 2 and 50 nm. Such a binder is, for example, known from Application WO 03/087002, and makes it possible to obtain particularly high photocatalytic activities.

The thickness of the photocatalytic coating is preferably greater than or equal to 5 nm, in particular 10 nm and/or less than or equal to 1 micron, in particular 50 nm when the coating is composed of titanium oxide. This is because large thicknesses lead to a high, and therefore undesirable, reflection of the visible radiation in certain applications where the optical appearance is important (in particular, glazing units). It is possible to insert, under the photocatalytic coating, at least one layer that has the role of reducing the light reflection of the material and/or rendering the coloration in reflection more neutral. This may be, in particular, layers or stacks of layers described in Application WO 02/24971. The photocatalytic coating may also itself be included in an antireflection stack, as described in Application WO 2005/110937.

The coating comprising titanium oxide is preferably in contact with the air, therefore the only layer deposited on the substrate or the last layer of the stack. The coating comprising titanium oxide may however itself be coated with a very thin, preferably non-covering, layer of an oxide comprising silicon, in particular and preferably based on silica (SiO₂). This layer makes it possible to confer prolonged photoinduced hydrophilic properties even in darkness and/or to improve the abrasion resistance of the stack. Its thickness is preferably less than or equal to 5 nm. Application WO 2005/040056 describes such overlayers.

The coating comprising titanium oxide may also be coated with a very thin metallic, preferably non-covering, layer (for example in the form of a microgrid), in particular based on a metal chosen from silver, platinum or palladium. This electrically conductive layer makes it possible to prevent the recombinations of the electron-hole pairs produced during the activation of the titanium oxide.

The or each wavelength-converting compound preferably comprises at least one ion of a rare earth or of a transition metal inserted in a mineral matrix. This is because mineral matrices have higher durabilities than organic matrices. The ions of rare earths (lanthanides) are preferred since they have the highest conversion efficiencies.

The ions of a rare earth or of a transition metal are preferably chosen from the Yb³⁺, Tb³⁺, Tm³⁺, Eu³⁺, Eu²⁺, Er³⁺, Pr³⁺, Nd³⁺, Dy³⁺, Ho³⁺, Ti²⁺, Ni²⁺, Mo³⁺, Os⁴⁺, Re⁴⁺, Mn²⁺, Cr³⁺ ions. It may be preferable to use two different ions, one that absorbs visible or infrared radiation and another that re-emits ultraviolet radiation after transfer of energy. The pairs formed by the Yb³⁺ ion (which absorbs for wavelengths close to 980 nm) with Tb³⁺ or Tm³⁺ or Er³⁺ make it possible, for example, to obtain high luminescence efficiencies. The pair of Pr³⁺/Nd³⁺ ions is also advantageous. In the case where an ion of a single nature is used, the Pr³⁺ or Er³⁺ ions are preferred.

It may be advantageous in applications of the glazing type to choose wavelength-converting compounds that absorb infrared radiation and not visible radiation, which is the case, for example, for compounds containing a Yb³⁺/Tb³⁺ or Tm³⁺ or Er³⁺ pair described previously.

The mineral matrix may be amorphous (it may, for example, be a glass), or crystalline. The advantage of choosing an amorphous matrix is that it may contain large amounts of ions. Crystalline matrices are however preferred since the environment of the ions (and therefore their emission/absorption spectrum) is perfectly controlled. Moreover, amorphous matrices generally contain more structural defects, which may lead to the creation of intermediate energy levels and thus facilitate de-excitations by non-radiative transfers (for example, by emission of phonons) or by radiative, but low-energy, transfers.

In the case where the matrix is crystalline, the active ion has to be able to be inserted in the crystal lattice in place of an ion of the matrix. Therefore, matrices containing yttrium (Y), lanthanum (La), gadolinium (Gd) or lutetium (Lu) atoms are preferred, since it has been observed that rare-earth ions could easily be substituted for these ions within a crystal lattice.

The phonon frequency of the crystalline matrix is preferably at least four times lower than the emission frequency so as to prevent de-excitations by non-radiative transfers. Therefore, the preferred crystalline matrices are chosen from halides (especially fluorides, but also bromides or chlorides), or oxides.

The mineral matrix is, for example, chosen (nonlimitingly) from NaYF₄, Y₂O₃, Y₂SiO₅, LaPO₄, TeO₂ or Y₃Al₅O₁₂ (YAG). The amount of dopant ions is generally between 0.01 and 50% (in moles relative to the ions for which they are substituted), more particularly between 5 and 50% when it is a question of Yb³⁺ and between 0.01 and 10% for the other dopant ions cited previously.

The following wavelength-converting compounds have proved particularly effective: Pr³⁺/Nd³⁺-doped TeO₂, Pr³⁺-doped Y₂SiO₅, Er³⁺-doped Y₃Al₅O₁₂, Yb³⁺/Tb³⁺-doped CaF₂, Yb³⁺/Tb³⁺-doped Y₂O₃ and Yb³⁺/Tb³⁺-doped NaYF₄. The term “doped” is understood to mean that the matrix comprises the ions cited, without necessarily prejudging the amount of ions present, which may be relatively high, as indicated previously.

The wavelength-converting compound may be included in the substrate. The latter may thus be a glass-ceramic comprising crystals and an amorphous binder, at least one portion of said crystals constituting wavelength-converting compounds. Glass-ceramics based on SiO₂/Al₂O₃/CaF₂ in which CaF₂ crystals are formed, which crystals insert Yb³⁺ and Tb³⁺ ions in their crystalline structure, are thus capable of absorbing radiation having a wavelength of 980 nm in order to re-emit a radiation centered about the wavelength of 380 nm.

The wavelength-converting compound may alternatively or cumulatively be included in a coating placed between the substrate and the coating comprising photocatalytic titanium oxide. This coating is referred to in the remainder of the text as a “wavelength-converting coating”.

The wavelength-converting compound may be included in the coating in the form of particles dispersed in a mineral or organic binder. These particles preferably have a size less than 500 nm, in particular 300 nm and even 200 nm or 100 nm so as not to generate parasitic diffusions capable of affecting the transparency of the material. Diffusion may also be avoided by choosing a binder for which the refractive index is equal to that of the particles. The amount of particles of the energy-converting compound within the binder is at least equal to 1% (by weight) and preferably greater than 5%. The thickness of the coating is preferably at least equal to 100 nm, preferably greater than or equal to 500 nm and even greater than or equal to 1 μm and/or less than or equal to 10 μm, or even 5 μm.

The organic binder may be, for example, of the acrylic, epoxy, cellulose or else silicone type, the latter type being preferred as it is less sensitive to a possible degradation by the photocatalytic titanium oxide. If necessary, a barrier layer may be placed between the wavelength-converting coating and the photocatalytic coating to prevent any degradation of the first coating by the second.

The mineral binder may be, for example, a binder made of a material chosen from silica (SiO₂), alumina (Al₂O₃), zirconia (ZrO₂) or a mixture thereof. This binder may especially be obtained by a process of decomposition of organometallic or halide precursors, for example a sol-gel type process or atmospheric pressure plasma-enhanced chemical vapor deposition (APPECVD). The binder may also be an enamel or a glaze, obtained by melting a glass frit deposited, for example, by screen printing.

The wavelength-converting coating may also be composed of a wavelength-converting compound. Contrary to the embodiment described previously, in which active particles were dispersed in a binder, the wavelength-converting compound forms the coating by itself.

Various techniques are possible for depositing this coating: chemical vapor deposition (CVD) techniques, in particular that are plasma-enhanced and at atmospheric pressure, techniques of the sol-gel type, or physical vapor deposition techniques, for example by sputtering especially enhanced by a magnetic field (magnetron sputtering process), or by evaporation. The coating, when the wavelength-converting compound comprises an amorphous mineral matrix, may also be an enamel or a glaze obtained by melting a glass frit deposited, for example, by screen printing.

A sublayer or a stack of sublayers reflecting at least one portion of the ultraviolet radiation is advantageously placed between the wavelength-converting coating and the substrate. The ultraviolet radiation emitted by the wavelength-converting compound is in fact isotropic, so much so that one portion of this radiation is emitted in the direction of the substrate and not in the direction of the photocatalytic coating. Owing to the sublayer that reflects at least one portion of the ultraviolet radiation, this portion of the radiation emitted is reflected toward the photocatalytic coating, thus making it possible to increase the activity of the latter. Stacks of sublayers containing at least three layers that alternately have high and low refractive indices are preferred since they have a very low reflection in the visible range, but a high reflection in the ultraviolet range.

One preferred embodiment consists of a transparent substrate made of soda-lime-silica glass coated with a layer of silica obtained by a sol-gel type process comprising wavelength-converting compounds in particulate form, this layer itself being surmounted by a silica layer also obtained by a sol-gel type process and comprising particles of titanium oxide crystallized in anatase form.

When the substrate contains alkali metal ions (the case, in particular, of soda-lime-silica glass, which contains around 13% by weight of sodium oxide), the latter are capable of migrating, especially under the effect of the temperature, within the layers that surmount the substrate. Since this migration is capable of causing a reduction in the luminescence efficiency of the wavelength-converting compounds, it is preferable to place a sublayer that acts as a barrier to the migration of the alkali metal ions between the substrate and the wavelength-converting coating. Such a sublayer, which is furthermore known, may be for example made of SiO₂, Al₂O₃, SiOₓC_{y}, Si₃N₄, SnO₂, etc.

Another subject of the invention are various products that incorporate the material according to the invention. When the substrate is transparent, especially when it is made of soda-lime-silica glass, the material according to the invention may be incorporated into a glazing unit, for example single, multiple and/or laminated glazing, bent and/or toughened glazing, clear or tinted glazing. The material according to the invention may also be incorporated into a display screen, an aquarium, a greenhouse, interior furnishings, tiling or a mirror. In the latter case, the substrate may be a mirror that comprises a sheet of transparent glass, deposited on one face of which is a layer of silver coated with a lacquer. The mirror obtained thus has self-cleaning and anti-fogging properties that are particularly appreciable, for example in a bathroom. The material according to the invention may also be used in optics and ophthalmics. The material may also be used as tiling, especially made of glass, for example as described in Application FR-A-2868799.

The material according to the invention, in particular when the substrate is fibrous, may be incorporated into a structure for filtering and purifying liquid or gaseous effluents.

Considering its properties of being activated by visible or infrared radiation, the material according to the invention may be used within a dwelling or a passenger compartment of a vehicle for degrading the organic soiling deposited on its surface.

The invention will be better understood in light of the exemplary embodiments explained below, which illustrate the present invention without however limiting it.

### EXAMPLE 1

In this example, the wavelength-converting compound was included in an enamel-type coating.

Micron-size particles of yttrium oxide (Y₂O₃) doped with 18 mol % of ytterbium Yb³⁺ and 2 mol % of terbium Tb³⁺ were dispersed in a glass frit having a low melting point (600° C.) based on silica and bismuth oxide. The paste obtained was deposited on a soda-lime-silica glass substrate by screen printing, then annealed for 6 minutes at a temperature of 680° C. After cooling, a 50 nm thick layer of titanium oxide was deposited in a known manner by chemical vapor deposition (CVD), using titanium tetraisopropylate as precursor.

The photocatalysis procedure was activated by excitation using a lamp that predominantly emitted between 900 and 1000 nm. Under this radiation, the wavelength-converting material emitted at 380 nm, a wavelength that triggers the photocatalytic effect.

### EXAMPLE 2

This example illustrates one embodiment in which the wavelength-converting compound was included in a coating by being dispersed in a silica sol-gel binder.

Added to 4 ml of a colloidal solution of nanoparticles of NaYF₄: 20 mol % Yb³⁺, 2 mol % Er³⁺ was 1 ml of a silica sol-gel sol. The diameter of the nanoparticles was 30 nm±10 nm, the concentration by weight of the colloidal solution in nanoparticles being 10%. The silica sol-gel sol was obtained by hydrolysis (duration=4 hours) of a mixture of tetraethoxysilane (TEOS), absolute ethanol and an aqueous solution having a pH=2.5 acidified using hydrochloric acid, the respective molar ratios of the various constituents of the mixture being 1:4:4. The solution containing the nanoparticles of NaYF₄: 20% Yb, 2 mol % Er³⁺ and of silica sol-gel was then deposited by spin-coating on a soda-lime-silica glass substrate previously cleaned using an aqueous solution containing 2 wt % of RBS (surfactant). The coating obtained was then dried at 100° C. for 1 hour, then annealed at 450° C. for 3 hours. The thickness of the coating was 450 nm, its light transmission being greater than 80% over the whole of the visible spectrum.

At the end of these steps, a photocatalytic coating based on nanoparticles of TiO₂ dispersed in a mesoporous silica sol-gel binder was deposited. In order to do this, 22.3 ml of tetraethoxysilane, 22.1 ml of absolute ethanol and 9 ml of HCl in demineralized water were mixed, in a first step, until the solution became clear (pH of 1.25), then the solution obtained was placed at 60° C. for 1 h. In a second step, added to the sol obtained previously was an organic structuring agent in the form of a solution of a polyoxy-ethylene/polyoxypropylene block copolymer sold by BASF under the registered trademark Pluronic PE6800 (molecular weight 8000), in proportions such that the molar ratio PE6800/Si=0.01. This was obtained by mixing 3.78 g of PE6800, 50 ml of ethanol and 25 ml of the sol. Nanoparticles of TiO₂ crystallized in anatase form and having a size of around 50 nm were added to the liquid composition thus obtained before the deposition on the sample, in an amount such that the atomic ratio Ti/Si was equal to 1. The deposition was carried out by spin-coating. The samples then underwent a heat treatment at 250° C. for 2 hours in order to consolidate the mesoporous coating and evacuate the solvent and the organic structuring agent. The pores of the coating thus formed had a size of 4-5 nm.

The photocatalysis procedure was activated by excitation using a lamp that predominantly emitted between 900 and 1000 nm. Under this radiation, the wavelength-converting material emitted at 380 nm, a wavelength which triggers the photocatalytic effect.

### EXAMPLE 3

In this example, the wavelength-converting compound was included in the substrate itself.

The substrate was a glass-ceramic obtained by ceramization of a mother glass of molar composition SiO₂ (47%) /Al₂O₃ (19%)/CaF₂ (28%)/TbF₃ (2%)/YbF₃ (3%). It may be considered that the wavelength-converting compound is composed of a matrix of CaF₂ doped with Tb³⁺ and Yb³⁺ ions.

A coating of TiO₂ having a thickness equal to 50 nm was deposited onto this glass-ceramic substrate. This coating was deposited by chemical vapor deposition (CVD) using titanium tetraisopropylate (TiPt) at 500° C.

The photocatalysis procedure was activated by excitation using a lamp that predominantly emitted between 900 and 1000 nm. Under this radiation, the wavelength-converting material emitted at 380 nm, a wavelength that triggers the photocatalytic effect.

1. A material comprising a substrate coated on at least one portion of at least one of its faces with a coating comprising photocatalytic titanium oxide, wherein said substrate and/or a coating placed between said substrate and said coating comprising photocatalytic titanium oxide comprises at least one compound capable of converting radiation having a wavelength in the visible or infrared range to radiation having a wavelength in the ultraviolet range (wavelength-converting compound).

2. The material as claimed in claim 1, wherein the substrate is made of glass, ceramic, glass-ceramic or a polymer material.

3. The material as claimed in claim 1, wherein the titanium oxide is at least partially crystallized in anatase form.

4. The material as claimed in claim 1, wherein the coating comprising titanium oxide is composed of titanium oxide.

5. The material as claimed in claim 1, wherein the coating comprising titanium oxide comprises particles of titanium oxide dispersed in an organic and/or mineral binder obtained via a sol-gel process.

6. The material as claimed in claim 1, wherein the at least one wavelength-converting compound comprises at least one ion of a rare earth or of a transition metal inserted in a mineral matrix.

7. The material as claimed in claim 6, wherein the at least one ion of a rare earth or of a transition metal is chosen from the group consisting of Yb³⁺, Tb³⁺, Tm³⁺, Eu³⁺, Eu²⁺, Er³⁺, Pr³⁺, Nd³⁺, Dy³⁺, Ho³⁺, Ti²⁺, Ni²⁺, Mo³⁺, Os⁴⁺, Re⁴⁺, Mn²⁺, and Cr³⁺ ions.

8. The material as claimed in claim 6, wherein the mineral matrix is crystallized.

9. The material as claimed in claim 6, wherein the mineral matrix is a halide, or an oxide.

10. The material as claimed in claim 9, wherein the mineral matrix is chosen from NaYF₄, Y₂O₃, Y₂SiO₅, LaPO₄, TeO₂ or Y₃Al₅O₁₂.

11. The material as claimed in claim 6, wherein the wavelength-converting compound is chosen from Pr³⁺/Nd³⁺-doped TeO₂, Pr³⁺-doped Y₂SiO₅, Er³⁺-doped Y₃Al₅O₁₂, Yb³⁺/Tb³⁺-doped CaF₂, Yb³⁺/Tb³⁺-doped Y₂O₃ and Yb³⁺/Tb³⁺-doped NaYF₄.

12. The material as claimed in claim 1, wherein the wavelength-converting compound is included in the substrate.

13. The material as claimed in claim 12, wherein the substrate is a glass-ceramic comprising crystals and an amorphous binder, at least one portion of said crystals constituting wavelength-converting compounds.

14. The material as claimed in claim 1, wherein the wavelength-converting compound is included in a coating (wavelength-converting coating).

15. The material as claimed in claim 14, wherein the wavelength-converting compound is included in the coating in the form of particles dispersed in a mineral or organic binder.

16. The material as claimed in claim 14, wherein the wavelength-converting compound is composed of a wavelength-converting compound.

17. The material as claimed in claim 14, wherein a sublayer or a stack of sublayers reflecting at least one portion of the ultraviolet radiation is placed between the wavelength-converting coating and the substrate.

18. A single, multiple and/or laminated glazing unit, bent and/or toughened glazing, clear or tinted glazing, display screen, aquarium, greenhouse, interior furnishings, tiling, mirror, or optical or ophthalmic article, incorporating the material as claimed in claim 1.
